(19) United States
(12) Patent Application Publication
(10) Pub. No.: US 2010/0244776 A1
(43) Pub. Date: Sep. 30, 2010

(54) Magnetic Motor

(76) Inventors: Steven Leonard, San Jose, CA (US); Paul Donovan, San Jose, CA (US)

Correspondence Address: Richard Brewster Main, Esq., Patents Pending, 9832 Lois Stiltner Court, Elk Grove, CA, 95624, US

(21) Appl. No.: 12/795,656

(22) Filed: Jun. 8, 2010

Related U.S. Application Data
(63) Continuation-in-part of application No. 12/344,242, filed on Dec. 25, 2008.

(51) Int. Cl. H02J 7/14; H02K 3/28; H02P 6/16; H02K 29/06; H02K 11/04; H02K 53/00; F03B 17/04

(52) U.S. Cl. 320/140; 310/210; 318/400.37; 310/68 B; 310/68 D; 415/916

(57) ABSTRACT

A magnetic motor system includes a brushless motor with interdigitated permanent magnets longitudinally mounted on a rotor at equal radial positions, and stator windings to drive the rotor in response to pulses from a timer/driver, and stationary recapture windings to recover energy that would otherwise go to waste. One set of batteries is used to drive the motor through the timer/driver, and bridge rectifiers connected to the stationary recapture windings provide electrical current to charge a second set of batteries. The rotor shaft output provides kinetic energy to drive electrical generators, air compressors, etc. A shaft encoder connected to the rotor provides the information needed by the timer/driver to know which stator winding should be pulsed and with what polarity. A power pulse is provided at least every 12.5 degrees of rotation, making the motor self starting.

### COPENDING APPLICATION

This Application is a continuation-in-part of U.S. patent application Ser. No. 12/344,242, filed by Steven Leonard and Paul Donovan Dec. 25, 2008, and titled, MAGNETIC AIR CAR. Such parent application is incorporated herein in whole by reference.

### FIELD OF THE INVENTION

The present invention relates to electrical motors, and more particularly to brushless motors with permanent magnets arranged in the rotor and one set of stator windings to drive the rotor and another set of windings to recover stray magnet energy.

### DESCRIPTION OF THE PRIOR ART

The maximum power that can be applied to a brushless direct current motor is very high because no commutator assembly is needed. The electromagnetic forces electrically generated by timed pulses to the stator windings impel the permanent magnets arranged on the rotor. The principal limitation to input power on a brushless motor is the resulting heat that can permanently demagnetize the rotor magnets.

In motors with brushes and commutators, high amperage inductive electrical currents are switches with the brushes in open air and the switch timing is fixed. As a result, a lot of arcing and wear was unavoidable. Usable voltages are also limited.

The magnetic fields generated by the stator windings and the permanent magnets spinning on the rotors of brushless motors spill out everywhere and escape doing useful work. The magnetic exchanges between the magnets and the stator windings represents only a portion of the whole. So various devices have been patented to recapture these otherwise wasted magnetic fields. See, U.S. Pat. No. 6,392,370, issued May 21, 2002; U.S. Pat. No. 6,545,444, issued Apr. 8, 2010; U.S. Pat. No. 7,081,727, issued Jul. 25, 2006; and, U.S. Pat. No. 7,109,671, issued Sep. 19, 2006. The motors described by these generally need to be pushed by a smaller starter motor to get them going and they have not been industrialized into practical systems that can be used in practical applications like magnetic generators or the magnetic air car described by the Present Inventors in U.S. patent application Ser. No. 12/344,242, filed Dec. 25, 2008.

There is a need for a self starting motor that can recapture magnetic energy and convert it back to electrical energy for storage and re-use later.

### SUMMARY OF THE INVENTION

Briefly, a magnetic motor system embodiment of the present invention includes a brushless motor with permanent magnets longitudinally mounted on a rotor at equal radial positions and stator windings to drive the rotor in response to pulses from a timer/driver, and a stationary recapture winding to recover energy that would otherwise go to waste. One set of batteries is used to drive the motor through the timer/driver, and a bridge rectifier is connected to the stationary recapture winding provides electrical current to charge a second set of batteries. The rotor shaft output provides kinetic energy to drive electrical generators, air compressors, etc. A shaft encoder connected to the rotor provides the information needed by the timer/driver to know which stator winding should be pulsed and with what polarity. A power pulse is provided at least every 12.5 degrees of rotation, making the motor self starting.

These and other objects and advantages of the present invention will no doubt become obvious to those of ordinary skill in the art after having read the following detailed description of the preferred SPS receivers which are illustrated in the various drawing figures.

### IN THE DRAWINGS

FIG. 1 is a functional block diagram of a system embodiment of the present invention;

FIGS. 2A and 2B are end view diagrams of a magnetic motor embodiment of the present invention and show the rotor and stator of a six magnet motor at two slightly different positions;

FIG. 3 is a perspective view of a six magnet rotor for the motor of FIGS. 2A and 2B;

FIG. 4 is a perspective view of a six magnet stator winding assembly for the motor of FIGS. 2A and 2B;

FIGS. 5A and 5B are end view diagrams of a magnetic motor embodiment of the present invention and show the rotor and stator of an eighteen magnet motor at two slightly different positions; and

FIG. 6 is a functional block diagram of a magnetic air car embodiment of the present invention that employs the magnetic motor of FIGS. 1, 2A, 2B, 3, 4, 5A, and/or 5B.

### DETAILED DESCRIPTION OF THE PREFERRED EMBODIMENT

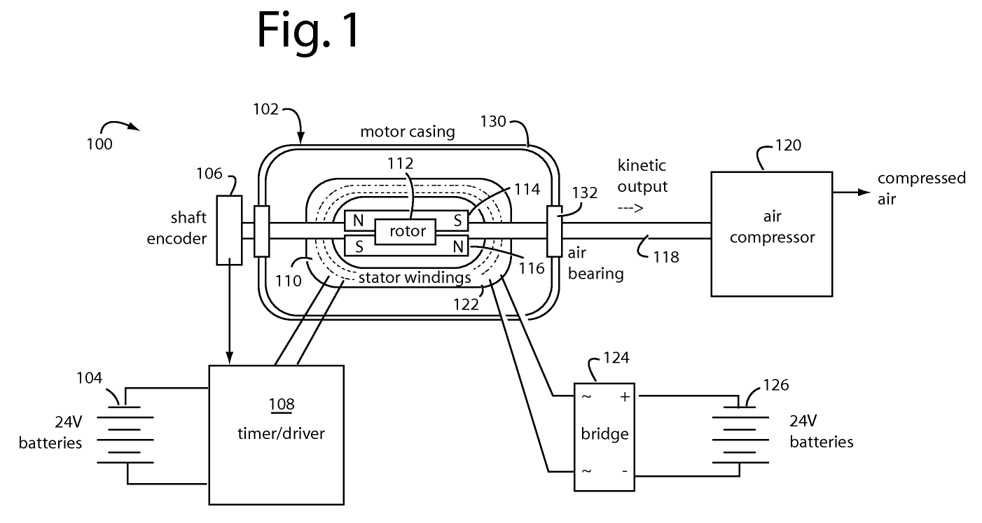

FIG. 1 represents a magnetic motor system embodiment of the present invention, and is referred to herein by the general reference numeral 100. The magnetic motor system 100 comprises a magnetic motor 102 that is powered by a set of 24-volt batteries 104. A shaft encoder 106 provides timing information to a timer/driver 108 that sends high current pulses at the right times and polarities to a set of electromagnetic stator windings 110. A rotor 112 is fitted with many bar-type permanent magnets represented by magnets 114 and 116. Pulsed magnetic fields from the stator windings 110 push and pull magnets 114 and 116 around an output shaft 118. In general, there should be a magnet and a matching stator winding disposed no more than 12.5-degrees around the entire 360-degrees of rotation.

Shaft encoder 106 can be implemented in a number of different ways. The simplest would be a simple cam with breaker points, or a commutator with brushes. A longer lasting and more reliable solution would be to mount small magnets on the shaft 118 and use Hall Effect sensors to detect when the small magnets orbit past. Optical sensors and also be employed that would be capable of reporting the exact angular position of shaft 118. Timer/driver 108 preferably has pulse width modulation capability for the output pulses it produces, and continuously variable timing advance and delay adjustments to optimize the timing of pulses to the relative angular rotation positions of the magnets 114 and 116 to their corresponding stator windings 110.

Timer/driver 108 could be implemented with a relatively modest microcontroller. The shaft encoder information is read periodically, and that reading is translated by a lookup table (LUT) into which stator winding should be switched on and which polarity to use. Simple high power switching transistors can be used for the driver outputs. It may be desirable to make such a look up table programmable, e.g., to vary motor speeds and output torque.

Output shaft 118, in turn, can be used to power an air compressor 120 and the compressed air can be used to propel a vehicle with a pneumatic engine. Alternatively, a generator could be attached to produce single-phase 120-VAC residential utility power, or three-phase 480-VAC commercial power.

A set of stationary recapture windings 122 interwoven with the stator windings 110 recovers electrical energy in the form of an alternating current (AC) that is full-wave rectified by a bridge rectifier 124. A direct current (DC) is output that can be used to charge another set of 24-volt batteries 126, and/or operate accessories.

In alternative embodiments, the charging currents from bridge rectifier 124 can be regulated to prevent overcharging of batteries 126, and/or to transfer between batteries 104 and 126 with a transfer switch. Various observations seem to indicate there may also be some benefit to battery life and recharging performance if the raw DC pulses and high frequency components are passed straight through to batteries 126 without any limiting or filtering.

A very strong, non-metallic motor casing 130 is needed for mounting the stator windings 110 and recapture windings 122, as they each can produce very strong mechanical oscillations and vibrations during operation and loading. Non-metallic materials, like carbon-fiber, and needed to control losses due to eddy currents. The motor casing 130 further must firmly support low friction shaft bushings or bearings, and air bearings 132 are preferred like those described in U.S. patent application Ser. No. 12/344,242, filed Dec. 25, 2008.

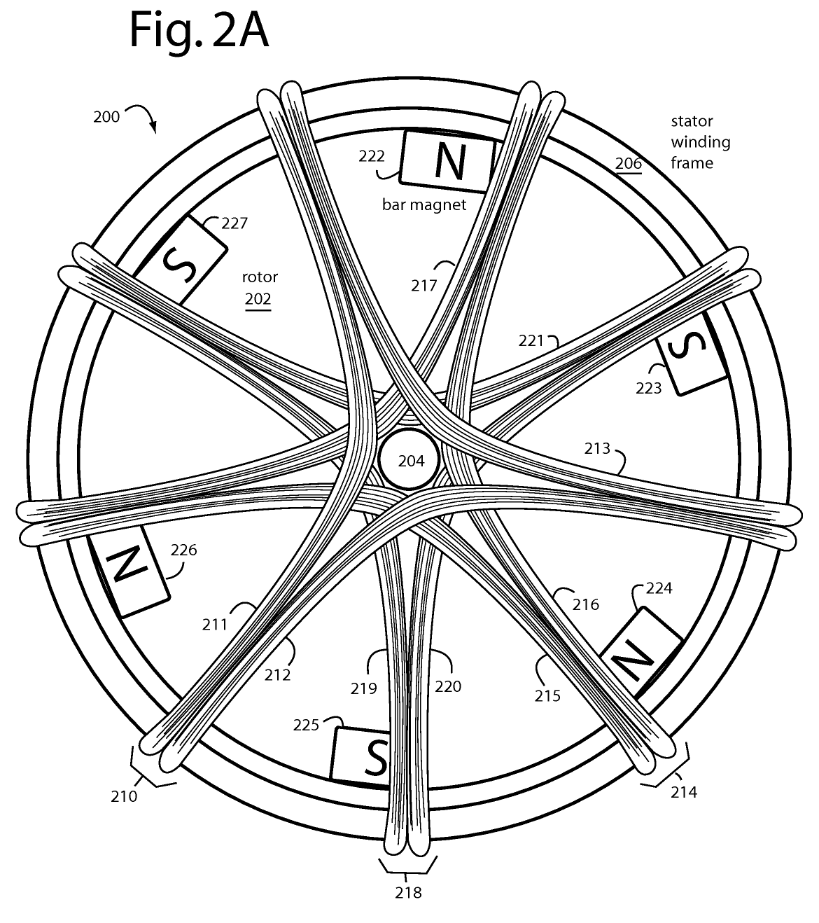

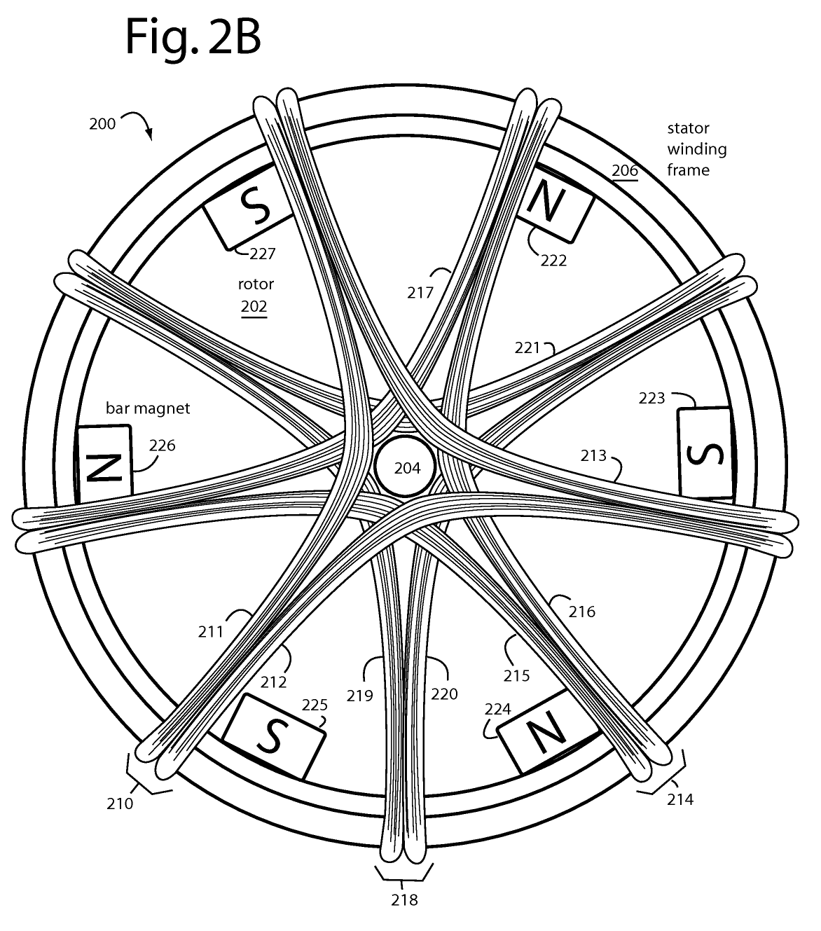

FIGS. 2A-2B represent one way the magnets on the rotor and stator windings of FIG. 1 can be configured. This example has been simplified by limiting the number of stator windings and magnets for purposes of this description, double, triple or more are possible in one stage or multiple tandem single-file stages all arranged on the same rotating shaft.

A motor 200, seen on end, has a rotor 202 that turns coaxially on a shaft 204 inside a cylindrical stator winding frame 206. In this example, three groups of stator windings each comprise three bundles of copper windings. A first stator winding group 210 includes individual bundles 211-213, a second stator winding group 214 includes individual winding bundles 215-217, and a third stator winding group 218 includes individual winding bundles 219-221.

The near-end N and S poles of six bar magnets 222-227 in six magnetic stations are seen in FIGS. 2A-2B. In one prototype, the bar magnets were neodymium HSO and 0.75″ by 0.375″ in cross section. For the clockwise rotation of rotor 202 in FIG. 2A, all the N-poles of magnets 222, 224, and 226 will be approaching the windings in the second winding group 214, and all the S-poles of magnets 223, 225, and 227 will be departing the windings in the third winding group 218. A well-timed pulse of the right polarity to second winding group 214 could pull in all the N-poles of magnets 222, 224, and 226, while an opposite pulse applied to the third winding group 218 could repulse all the S-poles of magnets 223, 225, and 227.

Only 20-degrees of clockwise rotation later, FIG. 2B shows that another opportunity to pulse the stator windings now presents itself. This time the first winding group 210 and the second winding group 214 will be activated, but this time in opposite polarity. The shaft encoder 106 (FIG. 1) is used to provide important timing information like this to timer/driver 108.

The important properties of permanent magnets in general are:
remanence (Bᵣ), which measures the strength of the magnetic field;
coercivity (H_{ci}), the material's resistance to becoming demagnetized;
energy product (BHₘₐₓ), the density of magnetic energy; and
Curie temperature (T_{c}), the temperature at which the material loses its magnetism and therefore the operating temperature limit for motor 200.

Rare earth magnets have higher remanence, much higher coercivity and energy product, but lower Curie temperatures than other types. The table below compares the magnetic performance of neodymium (Nd₂Fe₁₄B) and samarium-cobalt (SmCo₅) rare earth types with other kinds of permanent magnets.

| | Bᵣ | H_{ci} | (BH)ₘₐₓ | T_{c} |
|---|---|---|---|---|
| Magnet | (T) | (kA/m) | (kJ/m³) | (° C.) |
| Nd₂Fe₁₄B (sintered) | 1.0-1.4 | 750-2000 | 200-440 | 310-400 |
| Nd₂Fe₁₄B (bonded) | 0.6-0.7 | 600-1200 | 60-100 | 310-400 |
| SmCo₅ (sintered) | 0.8-1.1 | 600-2000 | 120-200 | 720 |
| Sm(Co,Fe,Cu,Zr)₇ (sintered) | 0.9-1.15 | 450-1300 | 150-240 | 800 |
| Alnico (sintered) | 0.6-1.4 | 275 | 10-88 | 700-860 |
| Sr-ferrite (sintered) | 0.2-0.4 | 100-300 | 10-40 | 450 |

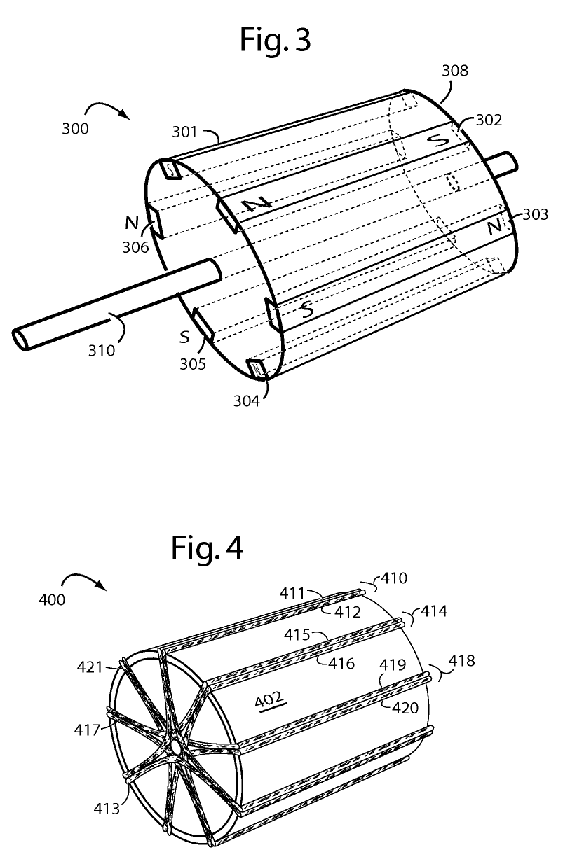

FIG. 3 represents a rotor 300 such as could be used in motor 200 (FIG. 2). Six bar magnets 301-306 are embedded in the cylindrical surface of a drum body 308. The bar magnets 301-306 are equally distributed, e.g., every 60-degrees, and alternate north (N) and south (S) poles. The rotor 300 turns on a central, coaxial shaft 310 and is balanced to eliminate vibration when spinning.

FIG. 4 represents a stator winding assembly 400. A non-metallic frame 402 is made of carbon-fiber in the form of a right cylinder, and such supports the many stator windings that are necessary to electromagnetically work on, e.g., magnets 301-306 in rotor 300. A first stator winding group 410 includes three individual bundles 411-413, a second stator winding group 414 includes three individual winding bundles 415-417, and a third stator winding group 418 includes three individual winding bundles 419-421.

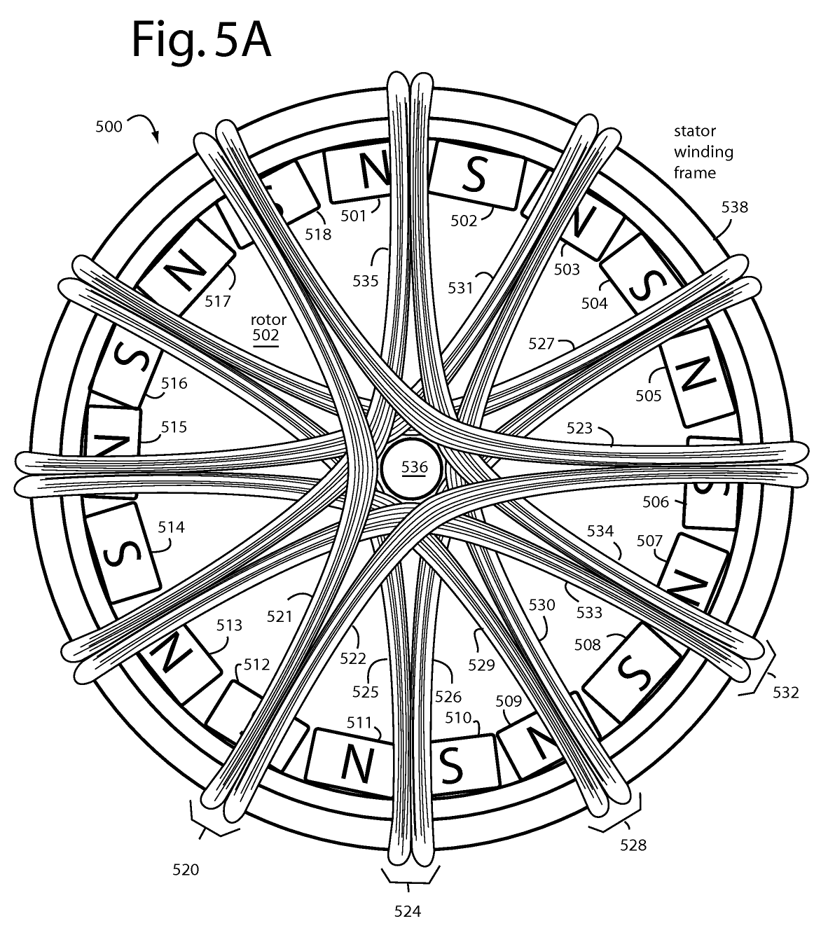

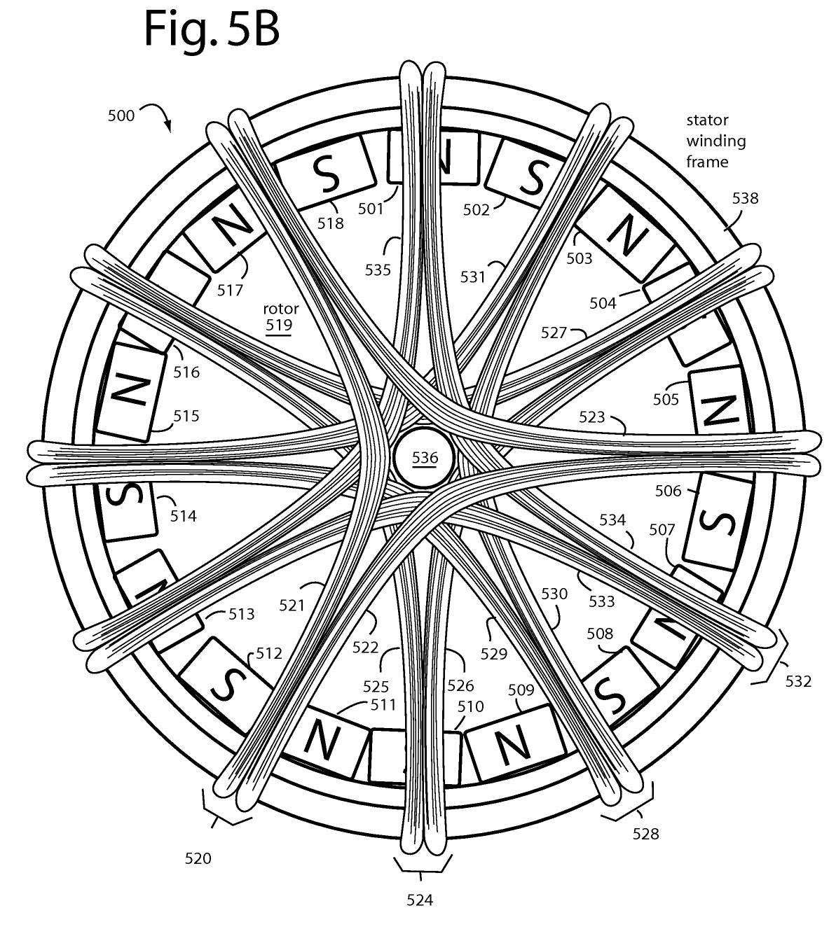

FIGS. 5A and 5B a second way the magnets on the rotor and stator windings of FIG. 1 can be configured. A motor 500, seen on end, has eighteen bar magnets 501-518 on a rotor 519. Motor 200 in FIGS. 2A-2B has only six. In this example, there are four groups of stator windings each comprising three bundles of copper windings. Motor 200 in FIGS. 2A-2B has only four.

A first stator winding group 520 includes individual bundles 521-523, a second stator winding group 524 includes individual winding bundles 525-527, a third stator winding group 528 includes individual winding bundles 529-531, and a fourth stator winding group 532 includes three individual winding bundles 533-535. Rotor 519 turns coaxially on a stainless steel shaft 536 inside a cylindrical stator winding frame 538 made of carbon-fiber materials. Epoxy encapsulents can be used to secure the winding bundles to the stator winding frame 538.

Assuming clockwise rotation of rotor 530 in FIG. 5A, all the N-poles of magnets 501, 507, and 513 will be approaching the windings in the fourth winding group 532, and all the S-poles of magnets 502, 508, and 514 will be departing. A well-timed pulse of the right polarity to fourth winding group 532 could pull in all the N-poles of the magnets 501, 507, and 513 and simultaneously repulse all the S-poles of magnets 502, 508, and 514. The other three winding groups 524, 528, and 532, will have similar opportunities as the rotor continues to turn clockwise. There are so many magnets and windings in this example that motor 500 can be self-starting and not have any dead spots that would necessitate a starter motor. The shaft encoder 106 used would therefore have to provide valid angular position information even when rotor 530 is stalled.

For example, FIG. 5B shows rotor 530 has advanced a little clockwise over the position shown in FIG. 5A. All the N-poles of magnets 505, 511, and 517 will be approaching the windings in the first winding group 520, and all the S-poles of magnets 506, 512, and 518 will be departing. A well-timed pulse of the right polarity to first winding group 520 could pull in all the N-poles of the magnets 505, 511, and 517 and repulse all the S-poles of magnets 506, 512, and 518. The next two winding groups 524 and 528 will have similar opportunities as the rotor continues to turn clockwise.

Timer/driver 108 (FIG. 1) could, for example, be configured to provide high energy pulses of the appropriate polarities and durations to winding groups 520, 524, 528, and 532 of motor 500. Particular applications may use one or more “flying capacitors” that are charged slowly between the delivered pulses, and when switched to the corresponding stator winding group have very low source impedances and can deliver very sharp pulses.

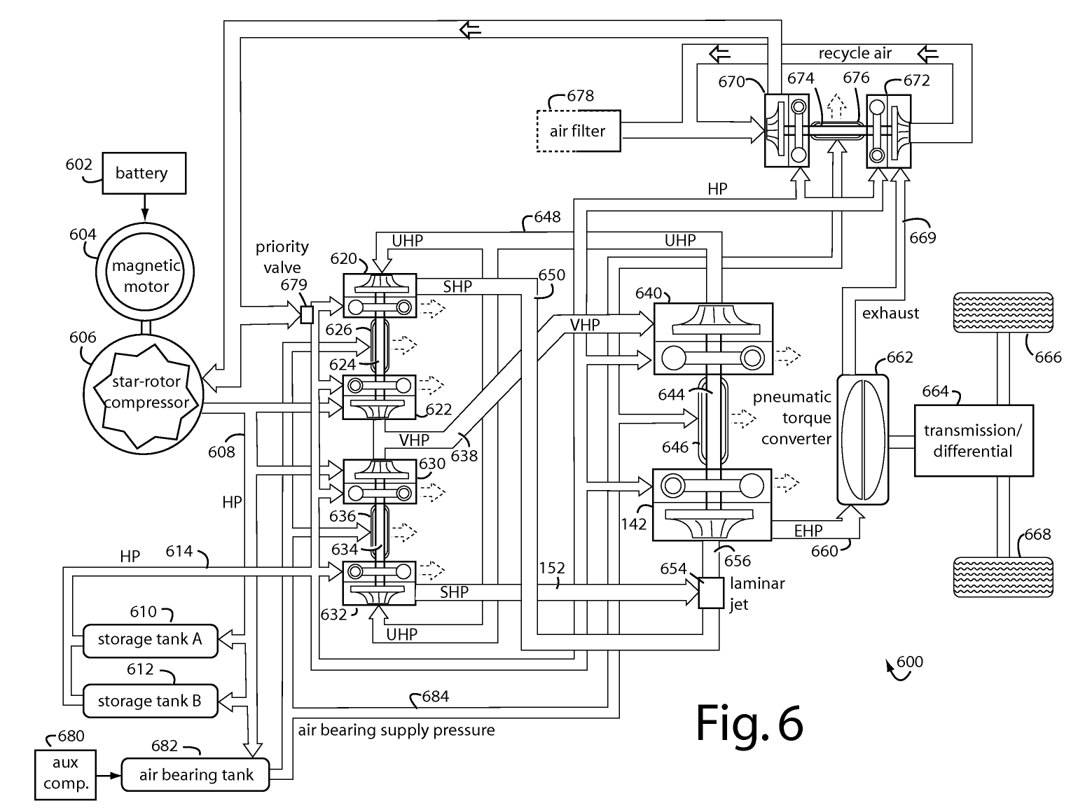

FIG. 6 represents a magnetic air car embodiment of the present invention, and is referred to herein by the general reference numeral 600. The magnetic air car 600 includes a storage battery 602 to operate a magnetic motor 604. Such magnetic motor has been described and illustrated in FIGS. 1, 2A, 2B, 3, 4, 5A, and 5B. The magnetic motor 604 drives a star-rotor compressor 606. The star-rotor type compressors have rotors which are synchronized not to touch one another during operation.

In one embodiment of the present invention, battery 602 includes a sodium free complex silicon salt electrolyte as described in PCT published patent application WO 01/13454 A1, published Feb. 22, 2001. Greensaver Technology Corporation (Ningbo, China) says they hold a patent for their so-called GREENSAVER BATTERY. Silicone Batteries USA imports these batteries to the US. See,www.siliconebatteriesusa.com/. The silicone battery is marketed as not having most of the bad qualities of lead acid batteries, e.g., high internal resistance, poor cold temperature performance, and significant self discharging rates. Silicone batteries are said to be able to present more than 80% of their total capacity even at temperatures as low as +15° F.

Filtered, ambient air or recycled pressurized air is pumped up to about 200-PSI by star-rotor compressor 606 to produce a high-pressure (HP) supply 608. A pair of tanks 610 and 612 are used to store pressurized air for release as HP supply 614 into a series of step-up compressors.

A first coupled pair of these are compressors 620 and 622 which have a common shaft 624 floated on an air bearing 626. This combination may be referred to herein as primary turbo TWIN1. Similarly, a second pair of compressors 630 and 632 have a common shaft 634 floated on an air bearing 636. This combination may be referred to herein as primary turbo TWIN2. HP supply 614 drives a pelton-type impulse turbine side of each compressor 620, 622, 630, and 636, and the exhaust is released to atmosphere. A pressure multiplication is provided like in a turbofan jet engine on the driven side of each compressor 620, 622, 630, and 636. This produces a very high-pressure (VHP) supply 638 from HP supply 608.

A large coupled pair of compressors 640 and 642 have a common rotating shaft 644 on an air bearing 646. This combination may be referred to herein as a secondary turbo BOOST. Compressors 640 and 642 are driven by HP supply 614. Compressor uses this to step up VHP supply 638 into an ultra high-pressure (UHP) supply 648. The driven sides of compressors 620 and 632 then step this up to a super high-pressure (SHP) supply 650 and 652. Both are applied to a laminar jet 654 to produce a laminar airflow 656 into the driven side of compressor 642.

The final result of all the pressure step-ups through compressors 620, 622, 630, 632, 640, and 642, is extra high-pressure (EHP) supply 660. This is applied to a pneumatic torque converter 662, the hydraulic equivalent of which is a standard automatic transmission torque converter used in automobiles. For example, this includes a pelton-type impulse turbine.

Pneumatic torque converter 662 couples with a driveshaft to a transmission and differential 664. The output torque is then used to drive axles to wheels 666 and 668 of a car. Power throttling is provided by modulating HP supply 608 from the star-rotor compressor 606.

Exhaust 669 from pneumatic torque converter 662 is ducted to a compressor pair 670 and 672. A shaft 674 on an air-bearing 676 couples these together. This combination may be referred to herein as exhaust turbo recovery. Ambient air drawn in by a filter 678, and recycle air from compressor 672, are input to compressor 670. They receive a boost that is applied to the input HP supply 614 through a priority valve 679 to boost acceleration while the car is under way. All ambient air exchange takes place through air filter 678.

The compressor pair 670 and 672, as do the others, provides a multiplication in the compressive pressures in gases that pass through the vanes of the driven sides. The multiplication is on the order of five to seven times.

An independent air bearing supply system includes an electric compressor 680, a dedicated air storage tank 682, and an air bearing supply pressure 684. A control system included with magnetic air car 600 must float all the air bearings 626, 636, 646, and 676 first, before allowing any supply pressure 608 or 614 to spool up any of the compressors. Any loss of air bearing supply pressure 684 must be immediately used to shut down supply pressure 608 and 614 to stop the compressors spinning. Air bearings could also be usefully employed in magnetic motor 604, star-rotor compressor 606, and torque converter 662. The electric compressor 680 could be powered by battery 602.

Accessories, other than electrically powered ones like power steering and power windows, can be provided with a mechanical power take off (PTO) from magnetic motor 604 or pneumatic torque converter 662. A small pneumatic motor could also be used to drive accessories like air conditioning, alternators, and generators from taps on the HP supply 608 or discharge from compressor 672.

The compressors are put in pairs around respective air bearings 626, 636, 646, and 676 to balance the lateral forces applied to the vane ends of shafts 624, 634, 644, and 674. A proper balance eliminates Milankovitch-like wobbles, e.g., changes in the axial tilt, axial precession, and eccentricities of the turbo-shafts 624, 634, 646, and 676 over periods of time.

A particular type of oil-free air bearing used in connection with a turbocharger is reported by Minoru Ishimo, “Air Bearing for Automotive Turbocharger”, in R&D Review of Toyota CDRL, Vol. 41, No. 3, (c) 2006, Toyota Central R&D Labs, Inc. Some of the details in the article may be useful in implementing compressors 620, 622, 630, 632, 640, 642, 670, and 672.

In general, a magnetic air car uses a magnetic motor to compress input air and save moderately compressed high-pressure (HP) air in storage tanks. The compressor and storage tanks deliver the high-pressure working air and operational flows to several stages of compressors that boost the pressures during driving to very high-pressure (VHP), then ultra high-pressure (UHP), then super high-pressure (SHP), and finally to extremely high-pressure (EHP). A pneumatic torque converter uses jets of the EHP to turn an input shaft of a transmission and differential. These, in turn, drive the powered wheels of a car. The compressors float a connecting shaft with matching vanes and impellers on opposite ends on air bearings to reduce shaft turning friction to near zero. The balance of forces between the two ends of a coupled turbo pair allows a simple air bearing design to operate safely and reliably at high rotational speeds.

Star-rotor compressor 606 can be like the fifth generation products marketed by StarRotor Corporation, Bryan, Tex. (See, starrotor.com). The Company reports that their compressor can process any vapor or gas with the only associated design consideration being the selection of materials compatible with the gases being compressed. The compressor works by using inner and outer star rotors, with seven and eight points respectively, that rotate on corresponding axes. A drive mechanism synchronizes the rotors so they do not bear on one another. Seals made with sacrificial coatings are used between the rotors and stationary porting components.

As the rotors turn, a chamber enlarges, reaches a maximum volume, and then squeezes closed. Inlet gas enters through the intake port as the void opens. Once the gas is captured, the chamber volume is squeezed causing the pressure to increase. After a design pressure is reached, the gas pushes out through a discharge port. The chamber ports open eight times per rotation of an outer rotor, allowing the compressor to process large volumes of gas. The position of the leading edge of the discharge port determines the compression ratio. If the leading edge is positioned to make the discharge port large, the compression ratio will be small. If the leading edge is positioned to make the discharge port small, the compression ratio will be high. By using a sliding mechanism, the leading edge position can be changed on the fly, giving the compressor a variable compression ratio. A magnetic motor could be integrated within to drive the compressor.

In operation, an electric motor driving auxiliary compressor 680 immediately begins filling the air bearing tank 682 when an ignition key is turned to the run position. The air bearing tank 682 supplies the pressurized air needed to suspend the air bearing loads of each component, e.g., 40-PSI@3.8 cubic feet per minute (cfm). Pressure sensors detect when a predetermined minimum operating pressure is present, and the magnetic motor 604 and star-rotor compressor 606 are allowed to start-up. Auxiliary compressor 680 is cycled on-off by pressure controller switches to keep a constant supply of compressed air in the air bearing tank 682.

When the car is not in use, the air bearings do not need to remain suspended. A timer is used to allow the air bearing equipped components to spin down. After enough inertia has been spent and the possibility of damage to the air bearings has been reduced to zero, the timer shuts-off air flow from the air bearing tank 680, and the car and all its engine components are stopped.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A magnetic motor system, comprising:
a brushless motor with interdigitated permanent magnets longitudinally mounted on a rotor at equal radial positions;
stator windings to drive the rotor in response to pulses from a timer/driver; and
stationary recapture windings to recover energy that would otherwise go to waste.

2. The system of claim 1, further comprising:
a first set of batteries used to drive the motor through the timer/driver;
a set of bridge rectifiers connected to the stationary recapture windings provide electrical current to charge a second set of batteries.

3. The system of claim 1, further comprising:
a rotor shaft output to provide kinetic energy to drive electrical generators, air compressors, etc.

4. The system of claim 1, further comprising:
a timer/driver connected to control independent stator windings; and
a shaft encoder connected to the rotor and configured to provide information to the timer/driver for which stator winding must be pulsed and with what polarity.

5. The system of claim 1, wherein:
a power pulse is provided at least every 12.5 degrees of rotation of the rotor such that the is motor self-starting.

6. A magnetic motor, comprising:
a rotor with a central shaft and a coaxially mounted drum body, and having six bar-type magnets equally disposed longitudinally on said drum body with alternating north-pole south-pole orientations;
a non-metallic stator frame on which are wound three equally disposed groups of three windings each 120-degrees offset from one another such that likewise-oriented bar-type magnets on the rotor will pass in proximity to all three such windings of a single group;
wherein an electrical pulse applied to each of said groups of three windings in succession will force the rotor to spin on its central shaft.

7. The magnetic motor of claim 6, further comprising:
a shaft encoder attached to the central shaft and configured to provide angular position information related to which of said three equally disposed groups of three windings are proximate to said likewise-oriented bar-type magnets on the rotor passing by.

8. The magnetic motor of claim 6, further comprising:
a timer/driver providing for the critical timing and switching of battery current to each of said three equally disposed groups of three windings at times said likewise-oriented bar-type magnets pass by on the rotor in proximity.

9. The magnetic motor of claim 6, further comprising:
a set of stationary recapture windings interwoven with said equally disposed groups of three windings and providing for the recovery of electrical energy in the form of an alternating current (AC) that can then be full-wave rectified to recharge a battery.

10. A magnetic motor, comprising:
a rotor with a central shaft and a coaxially mounted drum body, and having eighteen bar-type magnets equally disposed longitudinally on said drum body with alternating north-pole south-pole orientations;
a non-metallic stator frame on which are wound four equally disposed groups of three windings each 120-degrees offset from one another such that a set of three likewise-oriented bar-type magnets on the rotor will pass in proximity to all three such windings of a single group;
wherein an electrical pulse applied to each of said groups of four windings in succession can provide self-starting and will force the rotor to spin on its central shaft.

11. The magnetic motor of claim 10, further comprising:
a shaft encoder attached to the central shaft and configured to provide angular position information related to which of said three equally disposed groups of three windings are proximate to said likewise-oriented bar-type magnets on the rotor passing by.

12. The magnetic motor of claim 11, further comprising:
a timer/driver connected to receive angular position information from the shaft encoder, and for providing for critical timing and switching of battery currents to each of said four equally disposed groups of three windings at times a next set of three likewise-oriented bar-type magnets pass by on the rotor in proximity.

13. The magnetic motor of claim 10, further comprising:
a set of stationary recapture windings interwoven with said equally disposed groups of four windings and providing for the recovery of electrical energy in the form of an alternating current (AC) that can then be full-wave rectified to recharge a battery.
